(19) United States
(12) Patent Application Publication
(10) Pub. No.: US 2010/0195878 A1
(43) Pub. Date: Aug. 5, 2010

(54) SYSTEMS AND METHODS FOR LABELING 3-D VOLUME IMAGES ON A 2-D DISPLAY OF AN ULTRASONIC IMAGING SYSTEM

(75) Inventors: Michael Vion, Seattle, WA (US); Raphael Goyran, Seattle, WA (US)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindhoven (NL)

(21) Appl. No.: 12/665,092

(22) PCT Filed: Jun. 19, 2008
(86) PCT No.: PCT/IB08/52433

§ 371 Date: Dec. 17, 2009

Related U.S. Application Data
(60) Provisional application No. 60/945,606, filed on Jun. 22, 2007.

(51) Int. Cl. G06K 9/00; G06T 15/00

(52) U.S. Cl. 382/128; 345/419

(57) ABSTRACT

An ultrasonic diagnostic imaging system is disclosed for labeling 3-dimensional volumes displayed on a 2-dimensional image display. A 3-dimensional volume image of anatomy is created. A label for a point of interest on the 3-dimensional volume image is created. A curve connecting the label to the point of interest on the 3- dimensional volume is created in a 2-dimensional visual plane such that a projection of the label onto the 3-dimensional volume image is not coincident with the 3-dimensional volume. The label, curve and 3-dimensional volume are rendered for display on the image display so that the curve extends between the point of interest and the label and so that the curve is re-rendered as the 3-dimensional volume is re-rendered in response to changes in the orientation of the 3-dimensional volume.

This invention relates to systems and methods for labeling 3-dimensional volume images on a 2-D display in a medical imaging system.

General purpose ultrasound imaging systems are used to provide images of anatomical features that can be imaged using ultrasound. Typically, such systems provide 2-D cross-sectional views of the scanned anatomical features. But as ultrasound diagnosis has become more sophisticated and the technology more refined, ultrasound imaging systems can now display virtual 3-D volumes of entire organs and other regions within the body. Visualization of, for example, a human heart can be eased considerably by displaying the heart or a chamber of the heart as a volume. In modern ultrasound imaging systems, such images may be manipulated on-screen in real time. For example, such manipulation capability allows the sonographer to rotate the virtual 3-D image on-screen by manually manipulating controls of the ultrasound imaging system. This allows efficient examination of all areas of a volume of interest by simply rotating the 3-D rendering instead of selecting different 2-D cross-sectional views that may be less detailed. This obviates the need to select, display and analyze a number of such 2-D images in order to gather the same information as could be displayed with a single 3-D volume image of the same region.

During analysis of a 3-D ultrasound image, sonographers and other clinicians typically wish to attach labels or annotations to anatomical features of interest on the displayed anatomy. For example, a sonographer may wish to label the left ventricle of a 3-D image of the heart with a text annotation of “left ventricle.” Existing ultrasound imaging systems permit attaching such labels, but not without certain drawbacks. Such prior art systems attach labels and annotations directly to the 3-D image itself. The label or annotation is then bound to the 3-D image and any movement or rotation of the 3-D volume image results in movement of the label or annotation as well. Said another way, the point of interest on the 3-D volume is connected with the label or annotation such that they are and remain coincident. Unfortunately, if the 3-D volume is rotated such that the point of interest is on the back side of the 3-D image being displayed, the label or annotation will be not be visible on-screen.

There is therefore a need for an ultrasound imaging system that permits creation of 3-D volume labels and annotations that are always visible irrespective of the orientation of the volumetric image.

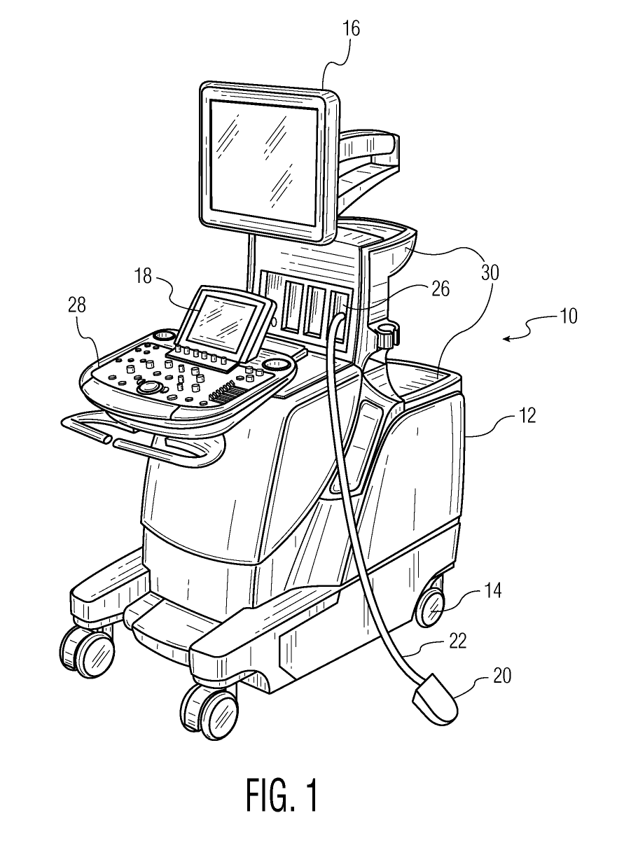

FIG. 1 is an isometric view of an ultrasonic imaging system according to one example of the invention.

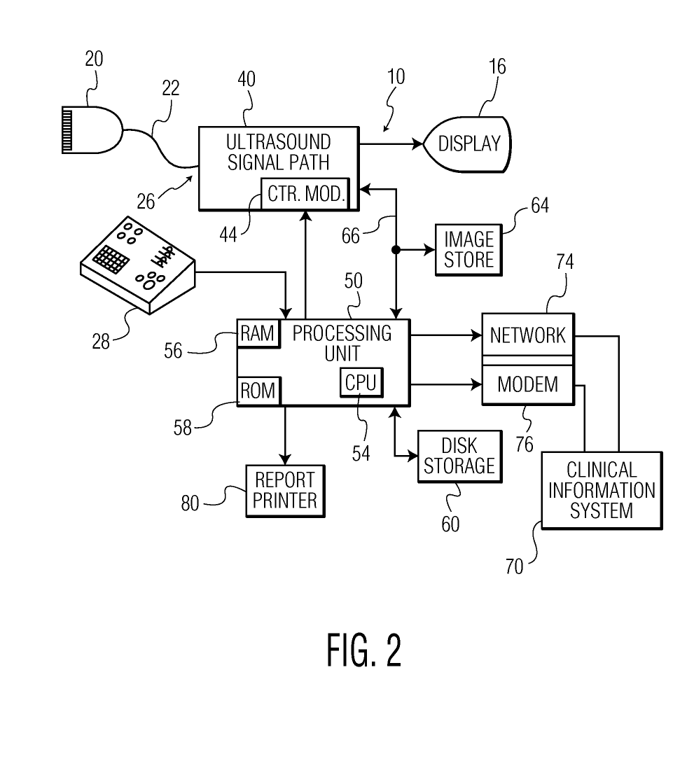

FIG. 2 is a block diagram of the major subsystems of the ultrasound system of FIG. 1.

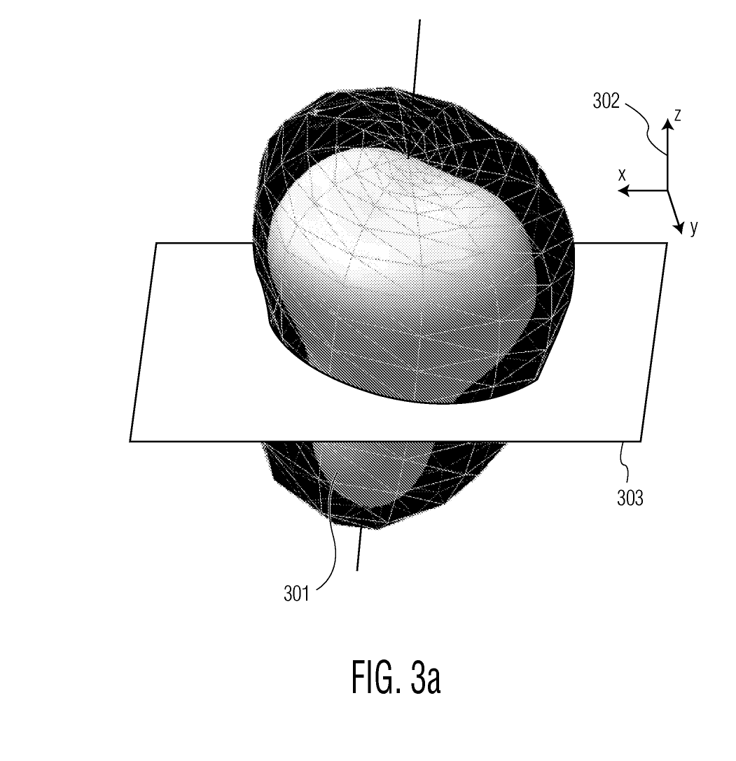

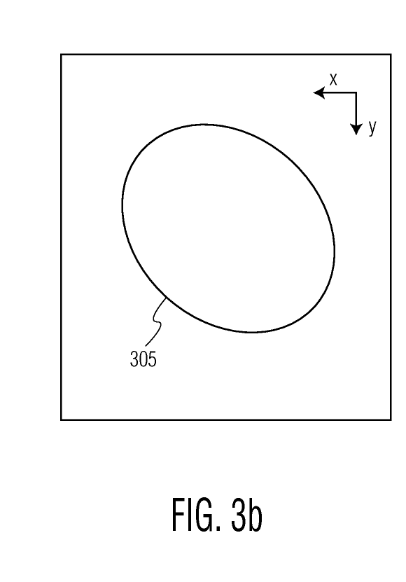

FIG. 3a is an example 3-D volume image produced using an ultrasonic imaging system.

FIG. 3b depicts one possible 2-D cross-section of the 3-D volume image of FIG. 3a.

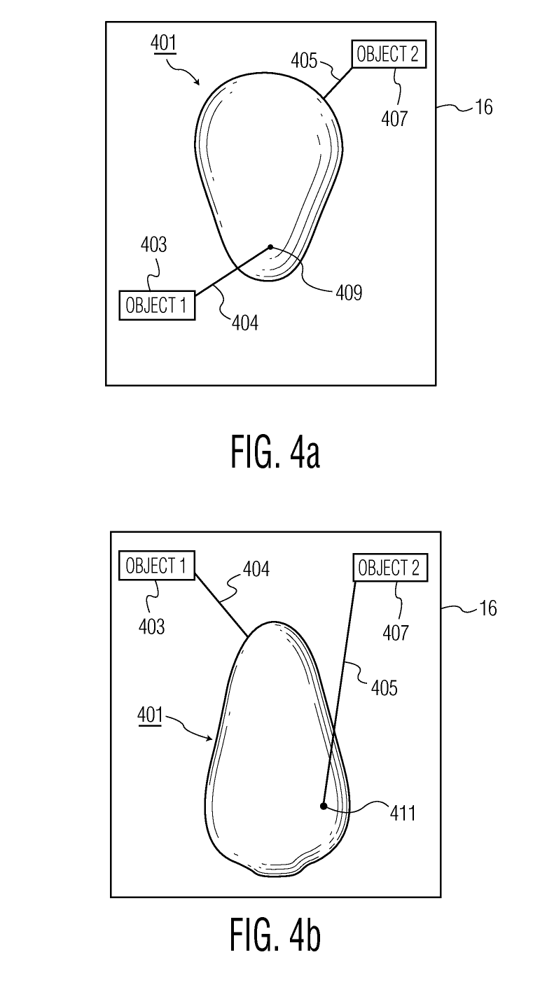

FIGS. 4a and 4b illustrate a 3-D volume image annotated in accordance with an embodiment of the invention.

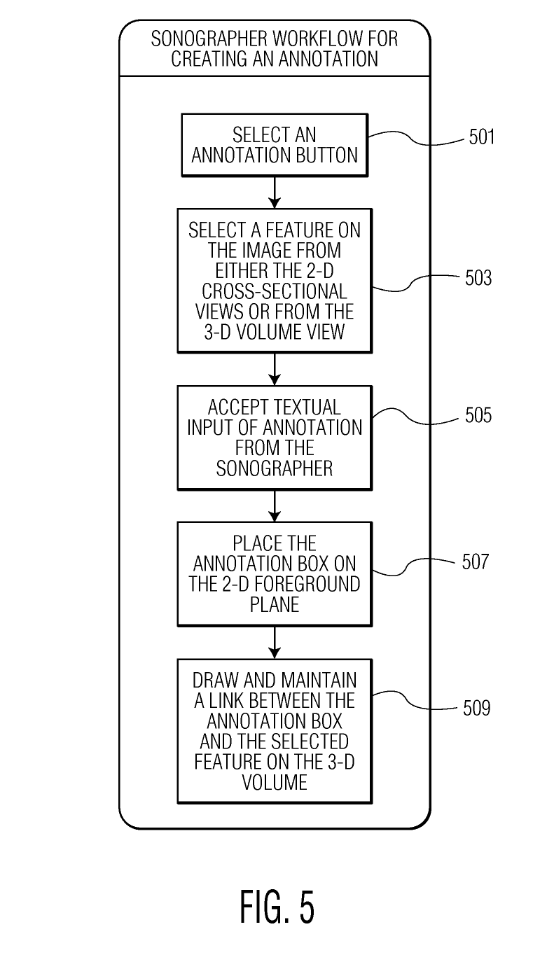

FIG. 5 is a flow diagram of a method for creating an annotation in accordance with an embodiment of the invention.

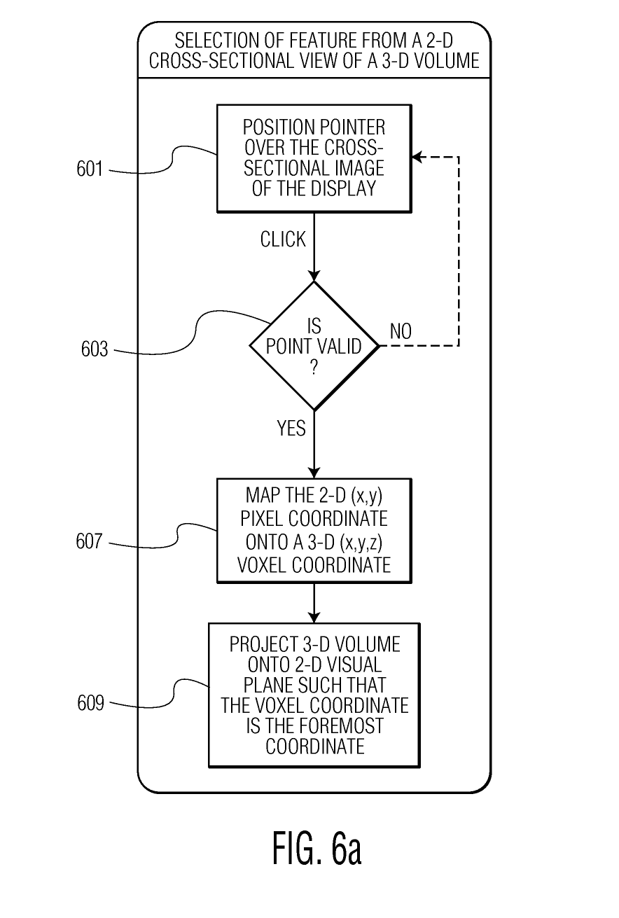

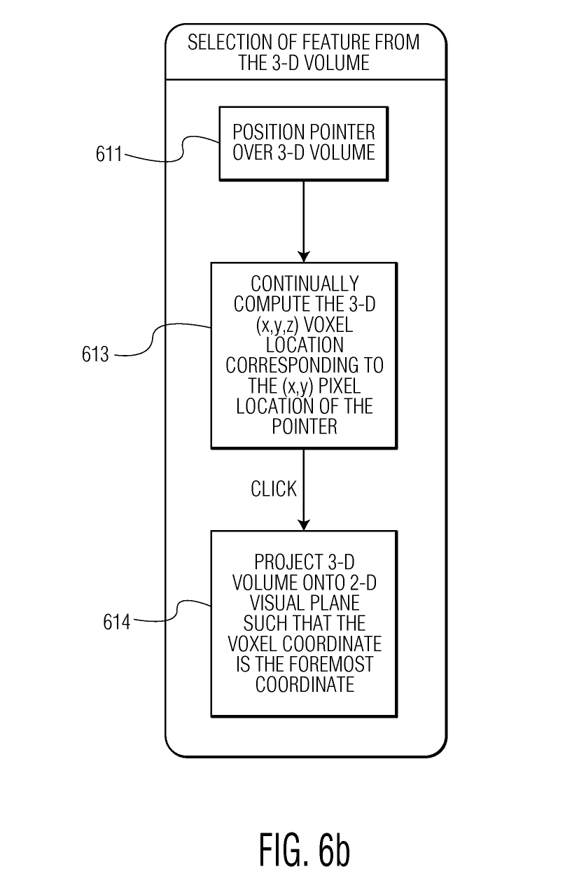

FIG. 6a is a flow diagram of a method for selecting a feature for annotation from a 2-D cross-sectional view of a 3-D volume.

FIG. 6b is a flow diagram of a method for selecting a feature for annotation from the 3-D volume directly.

An ultrasound system 10 according to one example of the invention is illustrated

FIG. 1. This ultrasound imaging system is used for illustrative purposes only and in other embodiments of the invention, other types of medical imaging systems may be used. The system 10 includes a chassis 12 containing most of the electronic circuitry for the system 10. The chassis 12 may be mounted on a cart 14, and a display 16 may be mounted on the chassis 12. An imaging probe 20 may be connected through a cable 22 to one of three connectors 26 on the chassis 12. The chassis 12 includes a keyboard and controls, generally indicated by reference numeral 28, for allowing a sonographer to operate the ultrasound system 10 and enter information about the patient or the type of examination that is being conducted. At the back of the control panel 28 is a touchscreen display 18 on which programmable softkeys are displayed for supplementing the keyboard and controls 28 in controlling the operation of the system 10. The control panel 28 also includes a pointing device (a trackball at the near edge of the control panel) that may be used to manipulate an on-screen pointer. The control panel also includes one or more buttons which may be pressed or clicked after manipulating the on-screen pointer. These operations are analogous to a mouse being used with a computer.

In operation, the imaging probe 20 is placed against the skin of a patient (not shown) and held stationary to acquire an image of blood and/or tissue in a volumetric region beneath the skin. The volumetric image is presented on the display 16, and it may be recorded by a recorder (not shown) placed on one of the two accessory shelves 30. The system 10 may also record or print a report containing text and images. Data corresponding to the image may also be downloaded through a suitable data link, such as the Internet or a local area network. In addition to using the probe 20 to show a volumetric image on the display, the ultrasound imaging system may also provide other types of images using the probe 20 such as two-dimensional images from the volumetric data, referred to a multi-planar reformatted images, and the system may accept other types of probes (not shown) to provide additional types of images.

The major subsystems of the ultrasound system 10 are illustrated in FIG. 2. As mentioned above, the ultrasound imaging probe 20 may be coupled by the cable 22 to one of the connectors 26, which are coupled to an ultrasound signal path 40 of conventional design. As is well-known in the art, the ultrasound signal path 40 includes a transmitter (not shown) coupling electrical signals to the probe 20 to control the transmission of ultrasound waves, an acquisition unit that receives electrical signals from the probe 20 corresponding to ultrasonic echoes, a beamformer for processing the signals from the individual transducer elements of the probe into coherent echo signals, a signal processing unit that processes the signals from the beamformer to perform a variety of functions such as detecting returns from specific depths or Doppler processing returns from blood flowing through vessels, and a scan converter that converts the signals from the signal processing unit so that they are suitable for use by the display 16 in a desired image format. The processing unit in this example is capable of processing both B mode (structural tissue) and Doppler (flow or motion) signals for the production of various B mode and Doppler volumetric images, including grayscale and colorflow volumetric images. In accordance with a preferred implementation of the present invention, the back end of the signal processing path 40 also includes a volume rendering processor, which processes a 3D data set of a volumetric region to produce an 3D volume rendered image. Volume rendering for 3D ultrasound imaging is well known and is described, for example, in U.S. Pat. No. 5,720,291 (Schwartz), where both tissue and flow data are rendered into separate or a composite 3D image. The ultrasound signal path 40 also includes a control module 44 that interfaces with a processing unit 50 to control the operation of the above-described units. The ultrasound signal path 40 may, of course, contain components in addition to those described above, and, in suitable instances, some of the components described above may be omitted.

The processing unit 50 contains a number of components, including a central processor unit (“CPU”) 54, random access memory (“RAM”) 56, and read only memory (“ROM”) 58, to name a few. As is well-known in the art, the ROM 58 stores a program of instructions that are executed by the CPU 54, as well as initialization data for use by the CPU 54. The RAM 56 provides temporary storage of data and instructions for use by the CPU 54. The processing unit 50 interfaces with a mass storage device such as a disk drive 60 for permanent storage of data, such as system control programs and data corresponding to ultrasound images obtained by the system 10. However, such image data may initially be stored in an image storage device 64 that is coupled to a signal path 66 coupled between the ultrasound signal path 40 and the processing unit 50. The disk drive 60 also may store protocols which may be called up and initiated to guide the sonographer through various ultrasound exams.

The processing unit 50 also interfaces with the keyboard and controls 28 for control of the ultrasound system by a clinician. The keyboard and controls 28 may also be manipulated by the sonographer to cause the medical system 10 to change the orientation of the 3-D volume being displayed. The keyboard and controls 28 are also used to create labels and annotations and to enter text into same. The processing unit 50 preferably interfaces with a report printer 80 that prints reports containing text and one or more images. The type of reports provided by the printer 80 depends on the type of ultrasound examination that was conducted by the execution of a specific protocol. Finally, as mentioned above, data corresponding to the image may be downloaded through a suitable data link, such as a network 74 or a modem 76, to a clinical information system 70 or other device.

FIG. 3a is an example 3-D volume image of the left ventricle of a human heart. A volumetric image 301 of the myocardium surrounding the left ventricular chamber is created by an ultrasound imaging system. In an exemplary ultrasound imaging system, the volume 301 may be generated with suitable processing equipment by collecting a series of 2-D slices along, for example, the z-axis as depicted on axes 302. One such slice could be created by directing ultrasonic sound energy into the left ventricle along a plane 303. The plane 303 is depicted in FIG. 3a for illustrative purposes and the medical system would not typically display the plane 303. FIG. 3b depicts a cross-sectional view of the left-ventricle 305 created by scanning along the plane 303 or reconstructing a 2D image along that plane. A number of 2-D slices may be created one after the other along the z-axis as depicted in the axes 302 of FIG. 3a. As is known in the art, suitable processing equipment within the medical system may aggregate the 2-D slice data to render a 3-D volumetric image of the entire left ventricle. In a preferred implementation the image data is acquired by a matrix array probe which includes a two-dimensional array of transducer elements which are controlled by a microbeamformer. With the matrix array probe, ultrasound beams can be steered in three dimensions to rapidly acquire image data from a volumetric region by electronic beam steering. See, for example, U.S. Pat. No. 6,692,471 (Poland) and U.S. Pat. No. 7,037,264 (Poland). The acquired 3-D image data may be volume rendered as described above, or reformatted into one or more 2-D image planes of the volumetric region, or only a single image plane may be steered and acquired by the probe.

FIG. 4a illustrates a 3-D volume rendering of a left ventricular chamber with annotations in accordance with an embodiment of the invention. A 3-D volume 401 may be created and displayed on the medical system by gathering 2-D slices of the volumetric region or electronically steering beams over the volumetric region, as discussed above, and creating a set of voxels. As is known in the art, a voxel is a display unit of a volume corresponding to the smallest element depicted in a 3-D image. Said another way, a voxel is the 3-D equivalent of a pixel. Numerous 3-D rendering techniques use voxel data to render 3-D scenes on a 2-D screen such as the display 16 of the medical system 10 of FIGS. 1 and 2. Such techniques may take advantage of various programming API's such as, for example, DirectX or OpenGL. FIG. 4 also depicts two annotation labels, Object1 403 and Object2 407. The Object1 annotation is referring to a feature 409 on the front surface of the volume 401, indicated by the dot at the end of link curve 404 between the Object1 label 403 and the feature 409, and is therefore visible in FIG. 4a. The feature 409 is linked to the Object1 annotation 403 by a link curve 404. In a similar manner, the Object2 annotation 403 is referring to a feature on the back surface of the volume 401. In this illustration, however, the feature on the back side of the volume 401 is not visible in FIG. 4a. That feature is, nevertheless, linked to the Object2 label 407 by a link curve 405.

In FIG. 4b the clinician has rotated the 3-D volume rendered image 401 of the left ventricular chamber in two dimensions, using the trackball or other control of the control panel 28 of the ultrasound system 10. The 3-D volume image has been rotated from front to back and from top to bottom. In this orientation of the volume image, it is seen that the feature 411 indicated by the Object2 label 407 is now on the front of the displayed volumetric region 401. The annotation 407 is still connected to the feature 411 by the dynamic link curve 411, which moves and extends to continually link the label 407 and the feature 411 as the volume 401 is rotated. Similarly, dynamic link curve 404 continues to connect the Object1 label 403 and its indicated feature 409. However, in this orientation of the volume image, the feature 409 is on the back surface of the volume and no longer visible. The Object1 annotation label 403 remains outside the periphery of the volume image 401, it continues to show that the feature 409 has been labeled and it continues to be linked to the feature 409 by the dynamic link curve 404, even though the feature is not visible in this orientation of the 3-D image.

In an embodiment of the invention, the Object1 403 and Object2 407 annotations are created in the 2-D plane foremost in the rendered image, the visual display plane. Because of this, they always remain visible no matter the orientation of the 3-D volume 401. Being in the foremost plane, the annotation labels can, in some embodiments, overlay the volume 401 but will still be visible because the will be, in effect, on top of the display planes of the volume 401. In another embodiment, the link curves 404 and 405 are dynamically re-rendered as the 3-D volume is manipulated to continually maintain a visual link between the Object1 403 and Object2 407 annotations and their respective features on the surface of the 3-D volume. Likewise, if either of the Object1 403 or Object2 407 annotations are moved, the link curves 405 and 411 are similarly re-rendered to connect the labels with their features. Embodiments of the invention may maintain and re-render these link curves by first: projecting the existing link curve onto the 2-D visual plane; second, re-computing the proper location of the link curve between the annotation box (which itself is already in the 2-D visual plane) and the anatomical feature; and third, projecting the link curve back onto the 3-D volume so that it may be properly rendered along with the 3-D volume. It should be noted that link curves may be any type of curve (e.g., a Bezier curve) or a link curve may be straight line as shown in this example.

In another embodiment, a navigation behavior is associated with each annotation such that selecting an annotation by, for example, double-clicking the annotation results in the 3-D volume being rotated to bring the associated anatomical feature to the foreground and, hence, into view. Such rotation is accomplished by first determining the 3-D voxel coordinates for the feature associated with the annotation that was clicked. Then, the 3-D volume may be rotated on an axis until the distance between the voxel and a central point on the 2-D visual plane is minimized. The 3-D volume may then be likewise rotated on each of the other two axes in turn. When these operations are complete, the anatomical feature associated with the annotation will be foremost and visible on the display.

FIG. 5 depicts an exemplary flow diagram of a method for creating an annotation in accordance with an embodiment of the invention. Assuming that the ultrasound system is already displaying a 3-D volume image and at least one cross-sectional image of that volume, the process flow begins at 501 with the sonographer initiating annotation creation by, for example, selecting an annotation button. Of course, use of an annotation button is only one means of signaling that the sonographer wishes to create an annotation and other options exist for giving this input to the medical system, such as a diagnostic protocol beginning with creating an annotation. After the ultrasound system enters an annotation creation mode, the sonographer is permitted to select a feature from either a 2-D cross-sectional view or from the 3-D volume image at step 503 of FIG. 5. This may be accomplished by, for example, using a pointing device to navigate an on-screen cursor to the feature of interest and clicking or pushing a button. Details of these selection processes are discussed in more detail below. After the feature has been selected, the ultrasound system prompts the user to input the text of the annotation at step 505. The ultrasound system then places a 2-D annotation box on the visual display plane at 507. Lastly, the ultrasound system will render and dynamically maintain a link between the annotation box and the selected feature on the 3-D volume at step 509. Once an 2-D annotation box is placed on the visual plane, an ultrasound system with an embodiment of the invention will permit the annotation box to be re-located within the screen while ensuring that the annotation box is not placed on another annotation box and is not placed on the 3-D volume itself.

FIG. 6a depicts an exemplary process flow that may be used when the sonographer is selecting an anatomical feature from a 2-D cross-sectional view of the 3-D volume in, for example, step 503 of FIG. 5. The process flow starts with the sonographer navigating a pointer over the cross-sectional region of the display at 601. The sonographer then clicks to select the feature of interest, the (x,y) screen coordinates of the location of the click are recorded, and process flow passes to step 603. At step 603, embodiments of the invention may check to see if the point designated by the (x,y) coordinates are valid. The point is generally valid only if the point lies on the perimeter of the cross-section since, in this example, it is a feature on the surface that is being annotated. If the point is invalid, then the sonographer is asked to select a different point and flow returns to step 601. Alternatively, an embodiment of the invention may prevent selection of invalid points by permitting the cursor to move only along the perimeter of the cross-section of the volume. Other means of preventing the selection of invalid points may also be used. Once the (x,y) coordinates of the point are validated at step 603, flow passes to step 607. At step 607, the 2-D (x,y) screen coordinates are mapped onto a 3-D (x,y,z) voxel coordinate using a suitable 3-D rendering API as discussed above. Once the 3-D voxel of interest has been identified, the ultrasound system may render and display the volume by projecting the 3-D volume onto the 2-D visual plane at step 609 such that the mapped voxel coordinate is the foremost coordinate.

FIG. 6b depicts an exemplary process flow that may be used when the sonographer is selecting an anatomical feature directly from a 3-D view in, for example, step 503 of FIG. 5. The process flow starts with the sonographer navigating a pointer over the 3-D volume at 611. At step 613, embodiments of the invention may continually and dynamically compute the 3-D (x,y,z) voxel location that corresponds to the (x,y) pixel location on the visual plane (i.e., the pointer location). When the sonographer clicks to indicate selection of the feature to be annotated, the voxel location last computed is used to project the 3-D volume onto the 2-D visual plane at step 614 such that the identified voxel coordinate is the foremost coordinate.

What is claimed is:

1. A method for labeling a 3-dimensional volume on a diagnostic imaging system display, comprising:
creating a 3-dimensional image of a volume;
identifying a point of interest on the volume image;
creating a label for the point of interest;
connecting the label to the point of interest with a curve;
rendering the label, curve and 3-dimensional volume for display on the imaging system display, the curve being dynamically linked to the label so that the curve extends substantially between the point of interest and the label on the imaging system display as the orientation of the 3-dimensional volume image on the imaging system display changes.

2. The method of claim 1 wherein creating a 3-dimensional image of a volume comprises assembling a plurality of voxels representing an anatomical feature being imaged.

3. The method of claim 2 wherein creating a label for the point of interest comprises:
accepting label text as input;
positioning a label including the label text in a 2-dimensional foreground plane; and
projecting the 2-dimensional foreground plane onto the 3-dimensional volume image to provide a label projection.

4. The method of claim 3 wherein connecting the label to the point of interest with a curve comprises using the label projection to create a computed curve between the label and the point of interest.

5. The method of claim 4 wherein rendering the label, curve and 3-dimensional volume comprises rendering the combination of:
the 2-dimensional foreground plane;
the computed curve; and
the plurality of voxels.

6. The method of claim 5 wherein positioning a label in a 2-dimensional foreground plane comprises positioning a label that does not overlap with any other label and does not overlap with the 3-dimensional volume image.

7. The method of claim 6 wherein identifying the point of interest on the 3-dimensional volume image comprises selecting at least one voxel from the plurality of voxels.

8. The method of claim 7 wherein the curve comprises at least one of a Bezier curve and a straight line.

9. The method of claim 1 further comprising:
selecting a label on the imaging system display; and
re-rendering the label, curve and 3-dimensional volume such that the point of interest connected to the label by the curve is visible on the imaging system display.

10. A medical diagnostic imaging system comprising:
a display;
a processor coupled to the display;
a user interface coupled to the display; and
an analysis package stored on a computer readable medium and operatively connected to the processor, the analysis package providing a user the ability to label 3-dimensional volumes on the display, the analysis package being configured to:
create a label for a point of interest in an image of the 3-dimensional volume;
connect the label to the point of interest with a curve; and
render the label, curve and 3-dimensional volume on the display, the analysis package rendering the curve so that the curve extends substantially between the point of interest and the label as the orientation of the 3-dimensional volume rendered on the display changes.

11. The medical system of claim 10 wherein the analysis package is further configured to create a 3-dimensional volume image by assembling a plurality of voxels representing an anatomical feature being imaged.

12. The medical system of claim 11 wherein the analysis package is further configured to create a label for a point of interest from the 3-dimensional volume by:
accepting as input the selection of a point of interest on the 3-dimensional volume image;
accepting label text as input;
positioning a label including the label text in a 2-dimensional foreground plane; and
projecting the 2-dimensional foreground plane onto the 3-dimensional volume image to provide a label projection.

13. The medical system of claim 12 wherein the analysis package is further configured to connect the label to the point of interest with a curve by using the label projection to create a computed curve between the label and the point of interest.

14. The medical system of claim 13 wherein the analysis package is further configured to render the label, curve and 3-dimensional volume by rendering the combination of:
the 2-dimensional foreground plane;
the computed curve; and
the plurality of voxels.

15. The medical system of claim 14 wherein the analysis package is further configured to position a label in a 2-dimensional foreground plane by positioning a label that does not overlap with any other label.

16. The medical system of claim 15 wherein the analysis package is further configured to position a label in a 2-dimensional foreground plane by positioning a label that does not overlap with the image of the 3-dimensional volume.

17. The medical system of claim 16 wherein a curve comprises at least one of: a Bezier curve and a straight line.

18. The medical system of claim 17 wherein the analysis package is further configured to:
permit selection of an existing label being displayed; and
re-render the label, curve and 3-dimensional volume such that the point of interest connected to the label by the curve is visible on the imaging system display.
